(19) United States
(12) Patent Application Publication
(10) Pub. No.: US 2007/0198844 A1
(43) Pub. Date: Aug. 23, 2007

(54) Method and control device for controlling access of a computer to user data

(75) Inventors: Peter Morawetz, Kahl (DE); Karsten Madsen, Ansager (DK)

Correspondence Address: WILLIAM COLLARD;COLLARD & ROE, P.C., 1077 NORTHERN BOULEVARD, ROSLYN, NY, 11576, US

(73) Assignee: utimaco safeware AG, Oberursel (DE)

(21) Appl. No.: 11/388,927

(22) Filed: Mar. 24, 2006

(30) Foreign Application Priority Data
Mar. 24, 2005 (DE) 10 2005 014 352.0

(51) Int. Cl. H04L 9/00

(52) U.S. Cl. 713/182

(57) ABSTRACT

A method for controlling access of a computer to user data that are stored in a memory device includes calling up structure data of the memory device, by means of a BIOS, and accessing the user data on the basis of the structure data. The structure data are only transmitted to the BIOS after authentication of a user. There is a control device for controlling access to user data. Structure data of the memory device can be called up by a controller, on the basis of which the user data are accessible. A user can be authenticated upon a request for the structure data and transmission of the structure data is controlled by the control device. When a request for structure data is issued, an authentication routine for authenticating the user is first transmitted by the control device to the BIOS, and carried out on the computer.

### BACKGROUND OF THE INVENTION

1. Field of the Invention

The invention relates to a method for controlling access of a computer to user data that are stored in a memory device. The computer first calls up structure data of the memory device, by means of a BIOS, and accesses the user data on the basis of the structure data. The structure data are only transmitted to the BIOS after authentication of a user. The invention also relates to a control device for controlling access to user data that are stored in a memory device, whereby structure data of the memory device can be called up by a controller of the memory device, by way of an interface, on the basis of which the user data are accessible. The user can be authenticated by means of the control device, upon a request for the structure data and, depending on the result of the authentication, transmission of the structure data can be controlled.

Within the framework of the generally known boot procedure of a personal computer (PC), the basic input/output system (BIOS) first determines the connected devices and memory devices, particularly connected hard disks. Then it calls up the so-called master boot record (MBR) by way of the controller of the first hard disk, for example cylinder 0, head 0, sector 1 (LBA 0), loads this into the memory, and carries out the executable machine code, the master boot routine, contained in this record starting from position 0. This routine reads the structure data of the hard disk, first contained in the partition table, subsequently contained in the MBR, determines the primary partition marked as active (bootable), and in turn loads the executable machine code contained in its physical first sector, the boot sector. This boot code, tailored to the operating system, in each instance, starts with loading of the start files (in the case of the DOS operating systems, the files msdos.sys and io.sys; in the case of UNIX operating systems, the kernel) of the operating system.

2. The Prior Art

A method and a control device of the type stated initially are known, for example, under the designation “secure IDE” (www.enovatech.net/products/reference/ide.htm). The known control device is looped into the IDE cable of a hard disk to be secured. If access to the connected hard disk is attempted, a logic implemented in the control device loads the authentication data stored in a personalized memory module, by way of a separate cable that passes out of the housing of the PC, and uses these data to determine a code for cryptographically encoded access to the hard disk.

The Achilles' heel of the known control device is authentication, because the code is stored on a proprietary token that must be connected with the control device at the time of booting. Any user who gains (unauthorized) possession of this token has access to the hard disk. The use of a hardware token makes integration of the known control device into the hard disk electronics more difficult. Furthermore, in the case of a defective or lost token, a replacement token is required in order to obtain access to the hard disk once again. Resetting or temporary release of the encoding, for example by means of challenge/response, is not available.

### SUMMARY OF THE INVENTION

It is therefore an object of the invention to simplify the handling of secure memory devices.

This object is accomplished according to the invention in that an authentication routine for authenticating the user is first transmitted to the BIOS, when a request for structure data is issued, and carried out on the computer. The method according to the invention utilizes resources that are available on the computer, even at the level of the BIOS (the logic for carrying out programs as well as monitor and input devices for communication with the user), and makes use of the user's memory for “storing” the data required for authentication. It therefore eliminates the need both for its own logic, and also for the separate, personalized memory module, and the cable required to connect it.

As the result of authentication, the authentication routine passes either the input data directly, or a value determined from them, back to the control device, which, depending on this, controls whether or not the requested structure data (the MBR with the partition table) are given back in the second step, in order to continue the boot procedure.

Preferably, the authentication routine requests the user's user name and password within the scope of a method according to the invention. Authentication by means of a non-coded name and (encrypted) password allows individual, personal allocation of the authentication data, and thereby facilitates their administration. Furthermore, this form of authentication is frequently familiar to the user and does not require any familiarization. Alternatively, it is also possible to request only the input of a password by way of the keyboard, or any desired individual action (for example an individual, specific sequence of mouse clicks on a surface or another form of graphic identification). Use in combination with two-factor authentication, for example by means of a smart card or with biometric data, is also possible. Since fundamental network functions (for booting by way of a network) are already made available in modern BIOS, the authentication routine can furthermore demand authentication data from a network address and prevent reading of the hard disk of a (stolen) PC by a user outside of the company network.

In a particularly advantageous variant of the method according to the invention, a code for cryptographically encoded access to the memory device is determined from data requested for authentication. For example, a strong AES 128-bit code can be generated from a comparatively weak combination of user ID and cryptic password, with a module that is implemented in the control device in fixed manner, which code effectively prevents unauthorized decoding of the memory device.

Proceeding from the known control devices, it is proposed, according to the invention, that when the structure data are called up, first an authentication routine for authentication of the user, which can be carried out by the BIOS of a computer, can be transmitted by the control device. Such a control device according to the invention allows implementation of the method according to the invention as described.

Particularly preferably, the control device according to the invention is integrated into the controller. Thus, the control device according to the invention can be implemented without additional hardware (and therefore without additional production costs), simply by re-programming of replacing the firmware of the controller. Neither BIOS expansions nor additional ISA or PCI plug-in cards are necessary for operating the control device according to the invention.

The control device according to the invention can be used as a bridge in a bus between a controller for the bus and the bootable memory device. Particularly preferably, the control device can be used as a bridge in an IDE bus. However, looping into an SCSI cable or also into a USB or fire-wire connection is also possible, as long as the BIOS, in each instance, allows booting by way of these connections.

Preferably, a control device according to the invention has a cryptography module by means of which access to the memory device is possible in cryptographically encoded manner. Implementation of coded access in a hardware module makes particularly fast encoding and decoding of the data stream to or from the memory device possible, without any delay in access that becomes noticeable for the user. Furthermore, the code stored in the control device is protected against discovery by unauthorized third parties, in the sense of a tamper-proof code.

A control device according to the invention can furthermore have a code generating module by means of which a code for access to the memory device can be generated from the user data requested for the authentication routine for authentication. Calculation of the code from the authentication data instead of the use of a code stored in the control device, in fixed manner, additionally increases security against unauthorized access to the memory device.

### DETAILED DESCRIPTION OF THE PREFERRED EMBODIMENT

The invention will be explained on the basis of an exemplary embodiment in the following. The control device according to the invention is first configured completely on an external administration station, so that no additional software is required on the target platform. It is then inserted into the IDE bus of the target platform (a PC), between the IDE controller and the memory devices to be secured, and functions as a bridge. The initial encoding of the connected memory device, as well as the decoding or encoding of each read or write access, take place in the background, by means of the control device, without any noticeable delays occurring during access to the memory device.

The control device offers the functionality of an automatically starting pre-boot authentication (PBA), without requiring a bootstrap code on a connected hard disk or a ROM BIOS expansion. For this purpose, the read request of the structure data of the MBR is captured by the control device according to the invention, during the boot procedure, and instead of the MBR, another code is first sent back to the BIOS, by means of which an authentication routine with a PBA screen is subsequently loaded. In this screen, the user must authenticate himself/herself by inputting his/her user name and password. The authentication data are transmitted to the control device. The control device generates a cryptographic code from the authentication data, and checks the code's validity for decoding the data carrier. In case of success, the authentication routine subsequently releases the working memory of the PC and again calls up the MBR. The control device delivers the latter (after successful authentication) back to the BIOS, so that the boot procedure can continue to run.

As compared with software-based encoding, the PBA carried out solely by means of the BIOS offers complete independence from the operating system. Modification of the BIOS of the main board is also not necessary.

Since no operating-system-dependent encoding driver is stored in protected files or sectors on the memory device either, no conflicts occur with backup, restore, or recovery programs. The control device according to the invention does not influence the procedures of the rollout, since the operating system is only started after configuration of the control device, for example. Alternatively, a data carrier that already contains non-encoded data can also be encoded subsequently, by means of activating the control device according to the invention. (Analogous to this, decoding of the data carrier is also possible by means of deactivation of the control device.)

Furthermore, no performance losses occur (at least not to a noticeable extent). As compared with the known method, no additional external, individualized hardware is required when using the control device according to the invention.

In the case of implementation of the control device according to the invention in an ATA system, no conflicts occur with hibernation; specific modification or expansion of the ATA command set is not required. The additional costs during production are negligible, if the control device is integrated into the controller of the hard disk.

Accordingly, while only a few embodiments of the present invention have been shown and described, it is obvious that many changes and modifications may be made thereunto without departing from the spirit and scope of the invention.

What is claimed is:

1. A method for controlling access of a computer to user data that are stored in a memory device, comprising the following steps;
requesting structure data of the memory device of a computer, by means of a BIOS;
accessing user data on the basis of the structure data; and
transmitting the structure data to the BIOS only after authentication of a user,
wherein authentication of the user is accomplished by an authentication routine that is first transmitted to the BIOS when structure data is requested, said authentication routine being carried out on the computer.

2. The method according to claim 1, wherein the authentication routine requests user name and password.

3. The method according to claim 1, wherein a code for cryptographically encoded access to the memory device is determined from data requested for authentication during the authentication routine.

4. A device for controlling access to user data that are stored in a memory device, comprising:
a controller that is adapted to call up structure data of the memory device, by way of an interface, on the basis of which data the user data are accessible; and
a control device for controlling the transmission of the structure data, the control device being adapted to transmit an authentication routine for authenticating the user that can be carried out by a BIOS of a computer when a request for structure data is issued.

5. The device according to claim 4, wherein the control device is integrated into the controller.

6. The device according to claim 4, wherein the control device acts as a bridge in a bus between the controller and a bootable memory device.

7. The device according to claim 6, wherein the control device acts as a bridge in an IDE bus.

8. The device according to claim 4, further comprising a cryptography module for accessing the memory device in cryptographically encoded manner.

9. The device according to claim 8, further comprising a code generating module for generating a code for access to the memory device, the code being generated from user data requested for the authentication routine.
